(19) United States
(12) Patent Application Publication
(10) Pub. No.: US 2019/0184400 A1
(43) Pub. Date: Jun. 20, 2019

(54) MICROSCOPE-OBSERVATION-SAMPLE PREPARATION BASE MATERIAL AND MICROSCOPE-OBSERVATION-SAMPLE PREPARATION METHOD

(71) Applicant: OLYMPUS CORPORATION, Tokyo (JP)

(72) Inventor: Katsunori OGO, Tokyo (JP)

(73) Assignee: OLYMPUS CORPORATION, Tokyo (JP)

(21) Appl. No.: 16/222,739

(22) Filed: Dec. 17, 2018

(30) Foreign Application Priority Data
Dec. 20, 2017 (JP) 2017-243356

(51) Int. Cl. B01L 3/00; G01N 1/30

(52) U.S. Cl. CPC B01L 3/56; B01L 2200/16; B01L 2200/0647; G01N 1/30

(57) ABSTRACT

Provided is a microscope-observation-sample preparation base material including: a base material body that includes: a flow path in which a medium solution is made to flow; a solution injection section that opens at one end of the flow path and into which the medium solution is injected; and a droplet supporting section that opens at the other end of the flow path and that supports a droplet of the medium solution injected from the solution injection section, in a hanging state, with a surface of the droplet being partially exposed, and an outside-air entry preventing member that prevents entry of outside air from the solution injection section into the droplet supporting section, in the flow path of the base material body.

### CROSS-REFERENCE TO RELATED APPLICATIONS

This application claims the benefit of Japanese Patent Application No. 2017-243356, the content of which is incorporated herein by reference.

### TECHNICAL FIELD

The present invention relates to a microscope-observation-sample preparation base material and a microscope-observation-sample preparation method.

### BACKGROUND ART

In recent years, attention has been paid to microscope observation of cellular aggregates, such as spheroids and organoids, which are obtained through 3D culturing. For preparation of a cellular aggregate, there is a known method in which cells are dispensed, together with a culture solution, to the inner surface of a lid of a petri dish in the form of a droplet, for example, this droplet is inverted to form a hanging drop, and cell aggregation is brought about inside the hanging drop with the help of a component force of gravity, in the direction along the curved surface of the hanging drop (for example, see PTL 1). However, because hanging drops are not subjected to accurate array arrangement, it is clear that this method is not suitable for automating the preparation of cellular aggregates.

There is a known multiwell-plate structure that allows hanging drops suitable for automation to be formed, by improving the technique of PTL 1 (for example, see PTL 2). The multiwell plate described in PTL 2 is formed by arranging, in an array, sets each of which includes a hollow section that receives a liquid discharged from a dispenser, a hanging-drop forming compartment that forms and holds a hanging drop, and a duct that leads to the hollow section and the hanging-drop forming compartment. In the multiwell plate described in PTL 2, it is not necessary to invert droplets, unlike the method described in PTL 1, and hanging drops can be formed by merely dispensing cells, a culture solution and the like from above the multiwell plate according to an array arrangement format, thereby facilitating automation of preparation of cellular aggregates in the hanging drops. However, PTL 2 does not mention anything about a high-definition observation method for a microscope, as in PTL 1.

There is a known technique capable of performing fine observation and image acquisition by means of a microscope by further developing the technique of PTL 2 (for example, see PTL 3). With the technique described in PTL 3, prepared cellular aggregates in hanging drops are dropped, together with the hanging drops, on wells of a multiwell plate, the bottom surfaces of the wells being flat and transparent, and light produced in each of the cellular aggregates is focused by an objective lens of an inverted microscope via the bottom surface of the corresponding well, thereby performing observation and image acquisition. However, with the technique of PTL 3, in a case in which the cellular aggregate is located so as to come in contact with a side surface of the well, a ridge-line section that is the boundary between a bottom surface of the well and the side surface thereof interferes with a light flux that should be received by an objective lens, thus making it impossible to get the best from the original optical performance of the microscope. In particular, in observation performed by using a light-sheet microscope, because excitation light is radiated onto the cellular aggregate from a lateral side, it is very difficult to observe a section where the cellular aggregate is in contact with the side surface of the well.

There is a known technique capable of fixing a cellular aggregate such that the bottom surface of the well and the cellular aggregate are not brought into contact with each other, by further developing the technique of PTL 3 (for example, see PTL 4). With the technique of PTL 4, a calcium chloride solution is made to act on a cell/alginate miscible solution to cause alginate to become a gel, and a sample in which cultured cells are enclosed in the alginate-bead-like gel is prepared. Furthermore, in the technique described in PTL 4, the alginate-bead-like gel is dissolved by being immersed in a chelating agent solution, the cultured cells are collected, and recultivation is performed.

### CITATION LIST

### Patent Literature

{PTL 1} DE patent invention No. 10362002 specification
{PTL 2} Publication of Japanese Patent No. 5490803
{PTL 3} PCT International Publication No. WO 2017/001680
{PTL 4} Japanese Unexamined Patent Application, Publication No. Hei 10-248557

### SUMMARY OF INVENTION

According to a first aspect, the present invention provides a microscope-observation-sample preparation base material including: a base material body that includes: a flow path in which a medium solution is made to flow; a solution injection section that opens at one end of the flow path and into which the medium solution is injected; and a droplet supporting section that opens at the other end of the flow path and that supports a droplet of the medium solution injected from the solution injection section, in a hanging state, with a surface of the droplet being partially exposed, and an outside-air entry preventing member that prevents entry of outside air from the solution injection section into the droplet supporting section, in the flow path of the base material body.

According to a second aspect, the present invention provides a microscope-observation-sample preparation method including: injecting a medium solution from a solution injection section that opens at one end of a flow path of a base material body, the medium solution being substantially transparent at the time of gelation or solidification; supporting, by means of a droplet supporting section that opens at the other end of the flow path of the base material body, a droplet of the medium solution injected from the solution injection section, in a hanging state, with a surface of the droplet being partially exposed, and an observation target being enclosed in the droplet; preventing entry of outside air from the solution injection section into the droplet supporting section, in the flow path of the base material body, in which the droplet is supported; and causing the droplet, which is supported by the droplet supporting section, to become a gel or a solid, in a state in which entry of outside air into the droplet supporting section is prevented.

### BRIEF DESCRIPTION OF DRAWINGS

FIG. 1 is a sectional view showing an example microscope-observation-sample preparation base material according to one embodiment of the present invention.

FIG. 2 is a view showing an example image acquired through bright-field observation of a hanging drop formed by using the microscope-observation-sample preparation base material shown in FIG. 1.

FIG. 3 is a view for explaining a vertically upward force due to the surface tension acting on the hanging drop, in the microscope-observation-sample preparation base material shown in FIG. 1.

FIG. 4 is a flowchart for explaining a microscope-observation-sample preparation method according to the one embodiment of the present invention.

FIG. 5 is a longitudinal sectional view showing a state in which a liquid for causing the liquid-state hanging drop shown in FIG. 1 to become a gel is brought into contact with the hanging drop in the form of a mist.

FIG. 6 is a sectional view showing an example microscope-observation-sample preparation base material according to a first modification of the one embodiment of the present invention.

FIG. 7 is a longitudinal sectional view showing, in an enlarged manner, the distal end of a lid member of the microscope-observation-sample preparation base material shown in FIG. 6.

FIG. 8 is a sectional view showing an example plate-like member used in a microscope-observation-sample preparation base material according to a second modification of the one embodiment of the present invention.

FIG. 9 is a perspective showing an example base material body adopted in the microscope-observation-sample preparation base material shown in FIG. 8.

FIG. 10 is a sectional view showing an example microscope-observation-sample preparation base material according to a third modification of the one embodiment of the present invention.

### DESCRIPTION OF EMBODIMENTS

### First Embodiment

A microscope-observation-sample preparation base material and a microscope-observation-sample preparation method according to a first embodiment of the present invention will be described below with reference to the drawings.

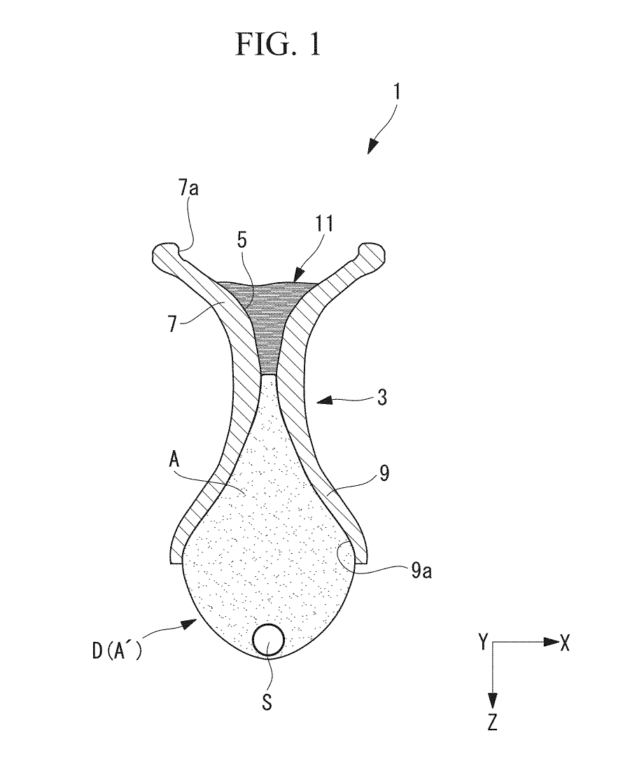

As shown in FIG. 1, a microscope-observation-sample preparation base material 1 of this embodiment is provided with: a base material body 3 that has a flow path 5 in which a medium solution A is made to flow and that forms a hanging drop D that is in a state in which a droplet A′ of the medium solution A is hanging; and a fluid member (outside-air entry preventing member) 11 that blocks the flow path 5 in the base material body 3.

The base material body 3 is provided with: an injection section (solution injection section) 7 that opens at one end of the flow path 5 and into which the medium solution A is injected; and a hanging-drop forming section (droplet supporting section) 9 that opens at the other end of the flow path 5 and that supports the droplet A′ of the medium solution A injected from the injection section 7.

The base material body 3 is used with the injection section 7 facing vertically upward and the hanging-drop forming section 9 facing vertically downward. Hereinafter, the vertical direction is referred to as the Z-direction, and directions that are perpendicular to the Z-direction and that are perpendicular to each other are referred to as the X-direction and the Y-direction.

The injection section 7 has an opening 7a that opens at one end of the flow path 5 and has a substantially conical shape that is narrowed in a tapered manner from the opening 7a and that leads to the hanging-drop forming section 9.

The hanging-drop forming section 9 has an opening 9a that opens at the other end of the flow path 5 and has a substantially conical shape that is gradually expanded radially outward from the thin section of the injection section 7. The hanging-drop forming section 9 supports the droplet A′ of the medium solution A in a hanging state, with a lower surface thereof being partially exposed.

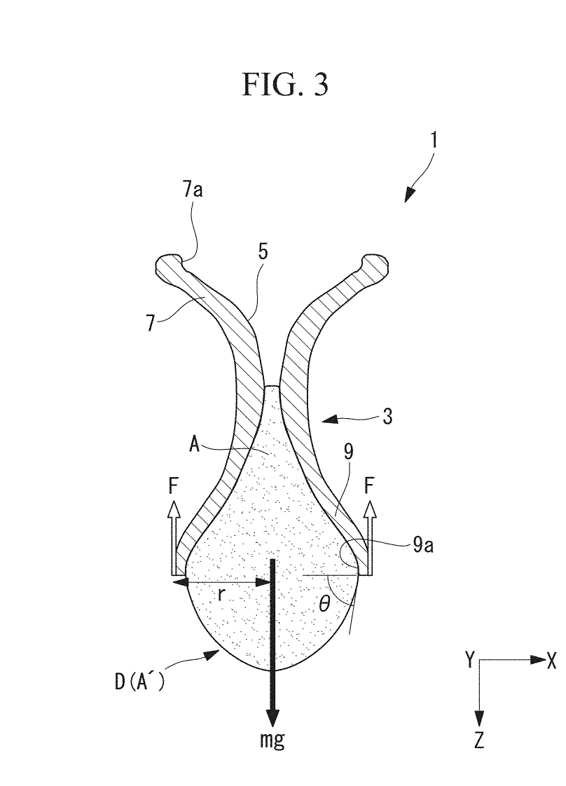

Specifically, as shown in FIG. 3, the hanging-drop forming section 9 can form the hanging drop D without dropping the droplet A′ of the medium solution A when a vertically upward force F due to the surface tension at the outer diameter of the opening 9a satisfies the relationship F≥mg.

Here, F=2πr×λ×cos θ, r indicates the outer radius of the opening 9a of the hanging-drop forming section 9, λ indicates the surface tension, m indicates the mass of a part of the droplet A′ exposed from the hanging-drop forming section 9, and g indicates the gravitational acceleration.

The fluid member 11 is formed of at least one substance having fluidity, e.g., resin, oil and fat, and gel, to be injected from the opening 7a of the injection section 7 of the base material body 3 to block the injection section 7 or the inside of the flow path 5, and thus prevents, in the flow path 5, the entry of outside air from the injection section 7 into the hanging-drop forming section 9. In this embodiment, a description will be given of an example case in which a photocurable resin is used as the fluid member 11.

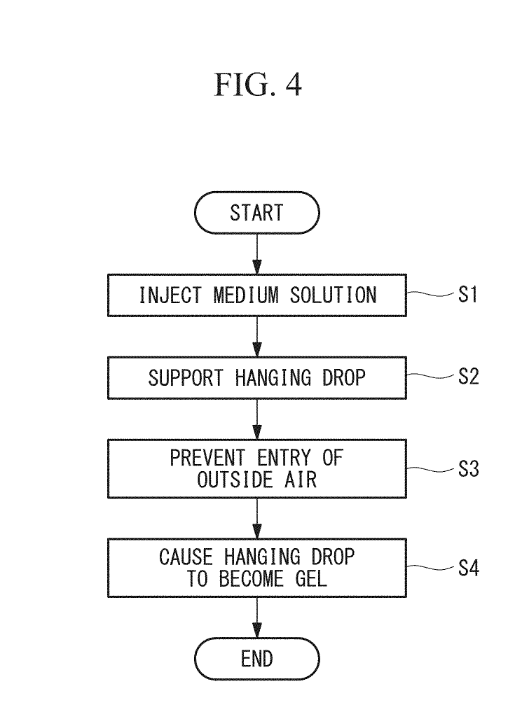

Next, as shown in the flowchart of FIG. 4, the microscope-observation-sample preparation method of this embodiment includes: an injection step S1 of injecting the medium solution A from the injection section 7 of the base material body 3; a support step S2 of supporting, by means of the hanging-drop forming section 9, a droplet A′ of the medium solution A, which is injected from the injection section 7, in a hanging state, with the surface thereof being partially exposed, and with a spheroid (observation target) S being enclosed therein, thus forming a hanging drop D; a prevention step S3 of preventing the entry of outside air from the injection section 7 into the hanging-drop forming section 9, in the flow path 5 of the base material body 3, which supports the hanging drop D; and a gelation step S4 of causing the liquid-state hanging drop D, which is supported by the hanging-drop forming section 9, to become a gel, in a state in which the entry of outside air into the hanging-drop forming section 9 is prevented.

For example, a culture medium that contains sodium alginate and that is capable of growing a biological material is used as the medium solution A. The medium solution A is transparent at the time of gelation. What is contained is not limited to sodium salt as long as it is alginate.

Furthermore, although it is preferable that the sodium alginate be 0.5 weight percent or more, the weight percent thereof is not limited thereto. The specific gravity of the medium solution A is 1 and is less than the specific gravity of the spheroid S.

In the support step S2, after the hanging drop D is formed, the spheroid S is inserted into the droplet A′ of the medium solution A from a lower section of the droplet A′, which is supported in a hanging state by means of the hanging-drop forming section 9.

In the prevention step S3, a liquid-state photocurable resin is injected, as the fluid member 11, into the injection section 7 of the base material body 3, and the injected photocurable resin is irradiated with light of a specific wavelength, thus being hardened. The photocurable resin injected into the injection section 7 is hardened, thereby making it possible to stably block the injection section 7.

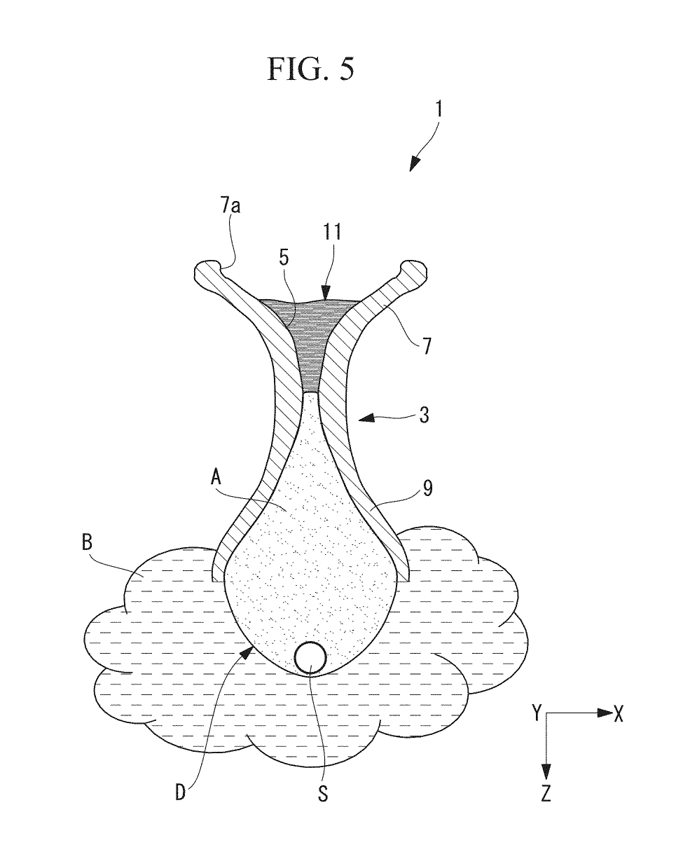

In the gelation step S4, for example, as shown in FIG. 5, a liquid B for causing the medium solution A to become a gel is brought into contact with the exposed surface of the hanging drop D, in the form of a mist, thus causing the hanging drop D to become a gel through a chemical reaction. An ultrasonic nebulizer device (not shown) that produces ultrasonic waves to turn the liquid B into a fine mist is used as a device for nebulizing the liquid B. For example, the hanging drop D, which is supported by the preparation base material 1, is accommodated in a container (not shown), and the ultrasonic nebulizer device turns the liquid B into a fine mist to fill the container with the fine mist, thereby bringing the liquid B into contact with the exposed surface of the hanging drop D, in the form of a mist.

For example, a calcium chloride solution or the like that is a solution containing divalent metal ion (calcium, magnesium, strontium, etc.) is used as the liquid B. Although it is preferable that the molar concentration of the calcium chloride be 100 mM or more, the molar concentration thereof is not limited thereto.

The operation of the thus-configured microscope-observation-sample preparation base material 1 and microscope-observation-sample preparation method will be described with reference to the flowchart of FIG. 4.

In order to prepare a microscope observation sample by using the microscope-observation-sample preparation base material 1 and the microscope-observation-sample preparation method of this embodiment, first, the medium solution A is dispensed, from above, into the injection section 7 of the base material body 3 (the injection step S1).

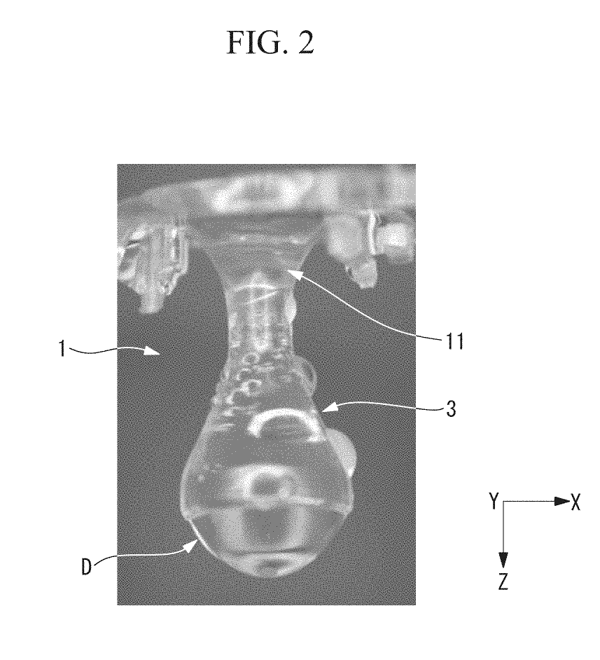

The medium solution A dispensed into the injection section 7 gravitationally moves downward from the injection section 7, and a droplet A′ is supported in a hanging state by the hanging-drop forming section 9. In this state, a spheroid S is inserted into the droplet A′ of the medium solution A from a lower section of the droplet A′. Accordingly, as shown in FIGS. 1 and 2, a hanging drop D that encloses the spheroid S and that is in a hanging state of the droplet A′ of the medium solution A is formed (the support step S2).

Because the medium solution A, which forms the hanging drop D, has a lower specific gravity than the spheroid S, the spheroid S gravitationally moves along the interface of the hanging drop D and settles in the vicinity of the lowest point of the hanging drop D. Therefore, the amount of the medium solution A to be dispensed into the injection section 7 is determined in advance, thereby making it possible to fix not only the positions of the spheroid S in the droplet A′ in the X-direction and the Y-direction but also the position thereof in the Z-direction. Furthermore, by using the base material body 3, it is not necessary to invert the droplet A′ of the medium solution A, in order to form the hanging drop D.

Next, the liquid-state photocurable resin, which serves as the fluid member 11, is injected from above the injection section 7 of the base material body 3, and the fluid member 11 is irradiated with light of a specific wavelength and is hardened in the injection section 7 (the prevention step S3). Accordingly, the injection section 7 or the inside of the flow path 5 is blocked, so that the entry of outside air, in the flow path 5, from the injection section 7 into the hanging-drop forming section 9 is prevented by the fluid member 11.

Next, the hanging drop D, which is supported by the preparation base material 1, is accommodated in a container (not shown), and the liquid B is nebulized by the ultrasonic nebulizer device, thus filling the container with a mist. Then, in a state in which entry of outside air into the hanging-drop forming section 9 is prevented by the fluid member 11, the liquid B is brought into contact with a surface of the hanging drop D that is exposed from the hanging-drop forming section 9, in the form of a mist.

The hanging drop D is left to stand still in the mist-state liquid B, and the liquid B is made to penetrate the inside of the hanging drop D from the lower exposed surface thereof, to cause the hanging drop D to become a gel up to the vicinity of the periphery of the spheroid S (the gelation step S4). Accordingly, a sample in which the spheroid S is fixed at the lowest position in the substantially transparent hanging drop D is prepared.

Accordingly, for example, by means of a light-sheet microscope or the like, excitation light is radiated onto the spheroid S in the gel-state substantially transparent hanging drop D, which is supported by the preparation base material 1, and light produced in the spheroid S is detected outside the hanging drop D, thus making it possible to observe the spheroid S.

After the observation of the spheroid S enclosed in the hanging drop D, it is also possible to cause a chelating agent or the like for dissolving the gel-state hanging drop D to act on the hanging drop D, thus liquefying the hanging drop D while maintaining a state in which the hanging drop D encloses the spheroid S and is supported by the base material body 3.

In this case, in a state in which entry of outside air into the hanging-drop forming section 9 is prevented by the fluid member 11, the chelating agent or the like may be sprayed on or applied to the surface of the gel-state hanging drop D, which is supported by the hanging-drop forming section 9, or the hanging drop D may be immersed in the chelating agent or the like. By liquefying the hanging drop D while maintaining the state in which the hanging drop D is supported by the base material body 3, it is possible to perform culture-medium replacement and continuous culturing on the same base material body 3, and to easily collect the spheroid S from the liquefied hanging drop D.

As described above, according to the microscope-observation-sample preparation base material 1 of this embodiment, the entry of outside air, in the flow path 5 of the base material body 3, from the injection section 7 into the hanging-drop forming section 9 is prevented by the fluid member 11, thereby making it possible to prevent the gel-state hanging drop D from dropping from the base material body 3 even when the liquid B, which causes the hanging drop D to become a gel, is attached to the surface of the hanging drop D, which is made to hang by the hanging-drop forming section 9, thus increasing the weight of the hanging drop D, or even when the hanging drop D becomes a gel, thus reducing the action of the surface tension.

Furthermore, even in a case in which the chelating agent or the like is attached to the gel-state hanging drop D, which is made to hang by means of the hanging-drop forming section 9, thus increasing the weight of the hanging drop D, it is possible to prevent the liquefied hanging drop D from dropping from the base material body 3 by preventing the entry of outside air from the injection section 7 into the hanging-drop forming section 9 by means of the fluid member 11. Therefore, it is possible to easily and stably perform gelation of the microscope observation sample and liquefaction thereof.

Furthermore, the fluid member 11, which is formed of a substance having fluidity, such as thermosetting resin, is adopted as the outside-air entry preventing member, thus making it possible to allow air in the flow path 5 to escape from the injection section 7 to the outside while pouring the liquid-state fluid member 11 from the injection section 7. Accordingly, it is possible to block the injection section 7 without pushing outside air from the injection section 7 to the inside of the flow path 5 and to prevent the hanging drop D from dropping from the hanging-drop forming section 9 when the injection section 7 is blocked.

Furthermore, according to the microscope-observation-sample preparation method of this embodiment, such a microscope observation sample can be easily prepared.

In this embodiment, although the spheroid S is inserted into the droplet A′ of the medium solution A from a lower section of the droplet A′ in the support step S2, instead of this, for example, it is also possible to enclose cells (not shown), which are biological materials, in the droplet A′ of the medium solution A and to culture the cells in the hanging drop D until the cells become a form to be observed.

In this case, the culture medium is dispensed into the opening 7a of the injection section 7 from above, together with a plurality of cells, in the injection step S1, and the hanging drop D is formed of a droplet of the culture medium, and the cells are cultured therein, thus forming a spheroid S, in the support step S2.

By doing so, it is possible to observe a spheroid S having a form suitable for being observed. Furthermore, cells are cultured in the hanging drop D to form a spheroid S, thereby eliminating the need to transfer the spheroid S, thus making it possible to improve the throughput and to perform screening at low cost.

Furthermore, in this embodiment, although a description has been given of a case in which the base material body 3, which is a single body formed of a single set of the injection section 7 and the hanging-drop forming section 9, is adopted as an example of the base material body, it is also possible to adopt a multiwell plate in which a number of such sets each including the injection section 7 and the hanging-drop forming section 9 are arranged in an array. By adopting such a multiwell plate, automatic dispensing is easy, and image acquisition of a large number of spheroids S for the purpose of screening can be performed with high throughput.

Furthermore, in this embodiment, although the ultrasonic nebulizer device is adopted, a device that can nebulize the liquid B can be adopted, and the device is not limited to a nebulizer device or the like for nebulizing the liquid B with ultrasound or through pressurization, for example.

Furthermore, instead of nebulizing the liquid B, for example, it is also possible to turn the liquid B into a droplet, such as a foam or a spray, that is smaller in volume than the droplet of the medium solution A and to bring it into contact with the surface of the droplet A′ of the medium solution A. In this case, for example, a spray device, a sputtering apparatus, or a pump may be adopted.

Furthermore, in this embodiment, although a description has been given of the spheroid S as an example observation target, instead of this, for example, it is also possible to adopt a biological material that is formed of cells, cellular aggregates, cellular tissues, or organoids. For example, the cells can be: cells derived from vertebrates, such as a human, a mouse, a rat, a dog, a monkey, a rabbit, a goat, a cow, a horse, a pig, and a cat; cells derived from invertebrates, such as a drosophila, and a silkworm; fungi, such as yeast and coliform; pluripotential stem cells, such as ES cells and iPS cells; stem cells, such as mesenchymal stem cells, fat stem cells, hematopoietic stem cells, neural stem cells, hepatic stem cells, and muscle stem cells. Furthermore, it is also possible to adopt, as the observation target, a non-biological material that has fluorescence, luminescence, phosphorescence, or pigment.

Furthermore, the base material may be manufactured by using, for example, inorganic substances including glass etc.; or organic substances including similar substances, such as synthetic rubber, dimethylsiloxane, silicone resin, natural rubber, fluorinated polymer, polyurethane, polyethylene, polyethylene terephthalate, polyvinyl chloride, polyolefin, polycarbonate, polystyrene, polydimethylsiloxane, polysiloxane-based polymer, polymethyl acrylate, polymethylhydrogensiloxane, polymethylmethacrylate, and methylhydrogensiloxane, a derivative, a friend, etc. It is also possible to adopt a base material prepared by using one or more of these materials.

This embodiment can be modified as follows.

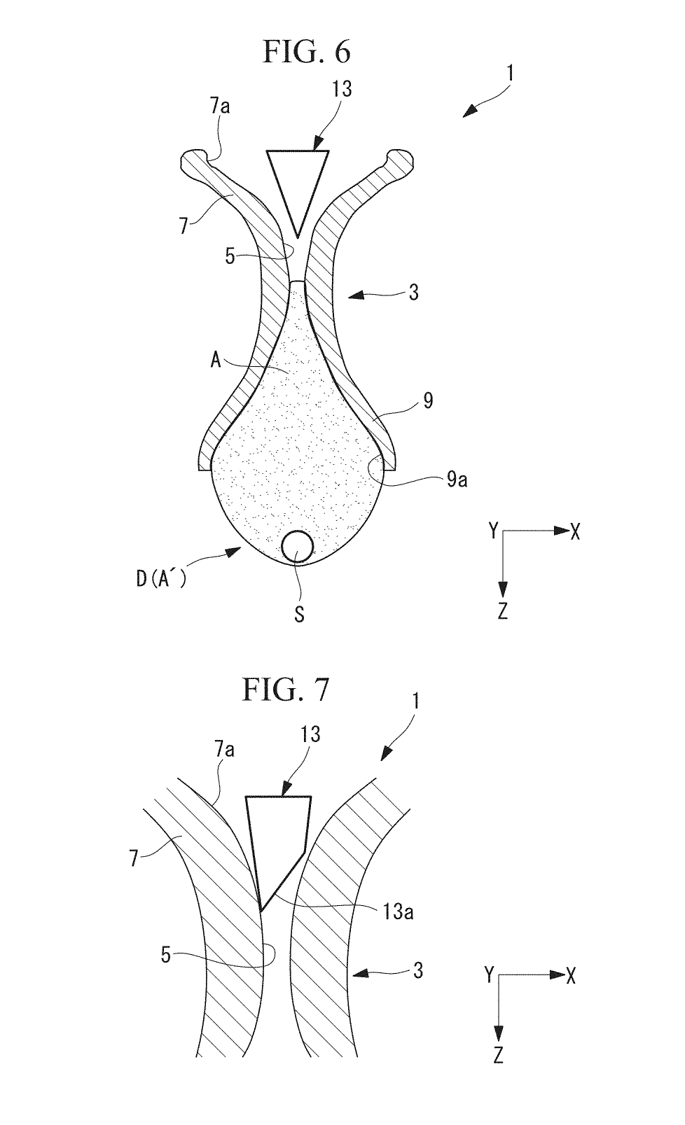

In a first modification, as shown in FIG. 6, for example, it is possible to adopt, as the outside-air entry preventing member, a lid member 13 that is removably inserted into the injection section 7 of the base material body 3 to block the injection section 7.

As the lid member 13, for example, resin, metal, or ceramic can be adopted, and the lid member 13 may be one that has such a shape as to be able to block the opening 7a by being inserted into the opening 7a of the injection section 7 and to open the opening 7a by being removed from the opening 7a.

By doing so, the injection section 7 can be easily blocked or opened by the lid member 13.

In this case, as shown in FIG. 7, the lid member 13 may have an inclined surface 13a that is inclined with respect to the direction along the flow path 5 such that a distal end section thereof to be inserted into the injection section 7 is tapered toward the distal end thereof. By doing so, when the lid member 13 is inserted into the injection section 7, air in the flow path 5 can be easily made to escape from the injection section 7 to the outside, along the inclined surface 13a of the distal end section of the lid member 13. Accordingly, it is possible to prevent a situation in which, when the lid member 13 is inserted into the injection section 7, outside air is pushed into the flow path 5 from the injection section 7, thus dropping the hanging drop D from the hanging-drop forming section 9.

Furthermore, the distal end section of the lid member 13 to be inserted into the injection section 7 may have a slit (not shown) extending in the direction along the flow path 5 of the base material body 3. By doing so, when the lid member 13 is inserted into the injection section 7, air in the flow path 5 can be easily made to escape from the injection section 7 to the outside, along the slit in the distal end section of the lid member 13.

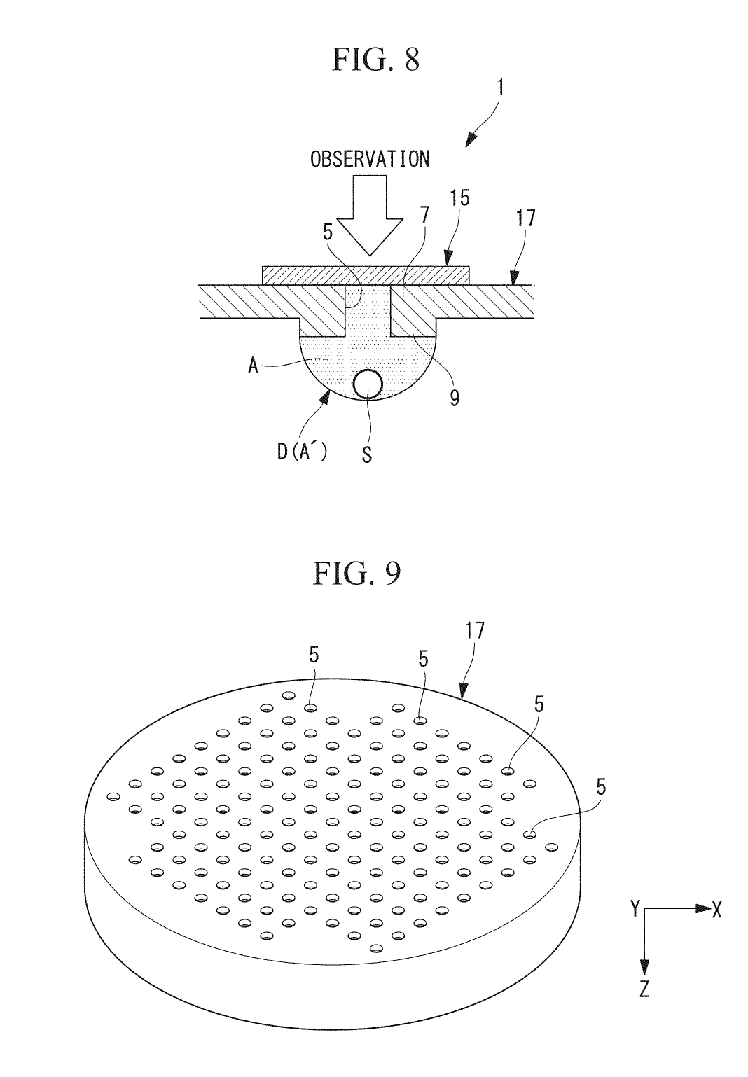

In a second modification, as shown in FIG. 8, it is possible to adopt, as the outside-air entry preventing member, a plate-like member 15 that is made of optically transparent glass or resin, for covering the opening of the injection section 7. In this case, as shown in FIG. 8, it is possible to adopt, instead of the base material body 3, a thin-plate-like base material body 17 having a flow path 5 that penetrates therethrough in the thickness direction. The base material body 17 has a thin-plate-like form, thereby making it possible to form the injection section 7, which opens at one end of the flow path 5, and the hanging-drop forming section 9, which opens at the other end of the flow path 5, into shapes close to each other.

According to this modification, the optically transparent plate-like member 15 is adopted, thereby making it possible to observe the spheroid S in the droplet A′ through the plate-like member 15 in a state in which the injection section 7 is blocked by the plate-like member 15. For example, excitation light is radiated onto the spheroid S in the hanging drop D through the plate-like member 15 from above the base material body 17, and light produced in the spheroid S is detected and observed below the base material body 17 from a direction intersecting the vertical direction.

In this modification, as shown in FIG. 9, the base material body 17 may have a plate-like form in which a plurality of flow paths 5 are arranged in an array. By doing so, the openings 7a of the injection sections 7 in the respective flow paths 5 can be blocked by the single plate-like member 15, and it becomes easy to automatically observe many samples.

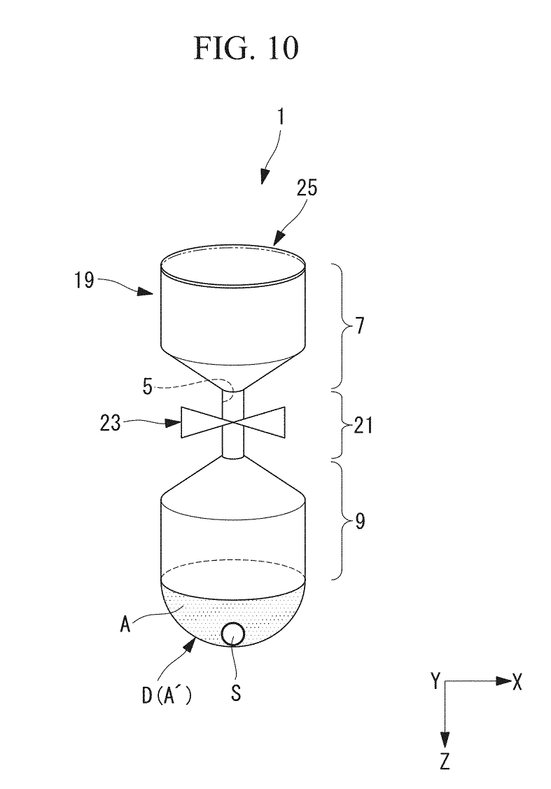

In a third modification, as shown in FIG. 10, it is possible to adopt, as the base material body, a base material body 19 that has an elongated duct 21 in which the diameter of the flow path 5 is reduced, between the injection section 7 and the hanging-drop forming section 9.

In this case, it is possible to adopt, as the outside-air entry preventing member, a valved plug 23 that can open and close an intermediate position of the flow path 5 in the duct 21. By doing so, through a simple task of merely opening/closing the valved plug 23 at the intermediate position of the flow path 5, it is possible to prevent the entry of outside air from the injection section 7 into the hanging-drop forming section 9 and to allow the entry of outside air from the injection section 7 into the hanging-drop forming section 9.

In this modification, it is also possible to adopt, instead of the valved plug 23, a lid member 25 that openably covers the opening of the injection section 7, as shown in FIG. 10, and the lid member 13, which is removably inserted into the injection section 7, or to use the valved plug 23 together with the lid member 25 and the lid member 13.

Although the embodiment of the present invention has been described in detail above with reference to the drawings, the specific configurations are not limited to this embodiment, and design changes etc. that do not depart from the scope of the present invention are also encompassed. For example, the present invention is not limited to the above-described embodiment and modifications, can be applied to an embodiment obtained by appropriately combining these embodiments and modifications, and is not particularly limited.

Furthermore, for example, in the above-described embodiment and the modifications thereof, a description has been given of an example case in which a solution containing sodium alginate is adopted as the medium solution A, and a solution containing divalent metal ion is adopted as the liquid B; however, it is also possible to adopt other solutions as the medium solution A and the liquid B as long as viscoelasticity suitable for observation and measurement can be imparted by bringing the liquid B into contact with the surface of the medium solution A, and the medium solution A and the liquid B are not limited thereto. Furthermore, a liquid for causing the medium solution A to become a solid may also be made to act on the surface of the medium solution A, thus causing the medium solution A to become a solid.

From the above-described embodiment, the following invention is derived.

According to a first aspect, the present invention provides a microscope-observation-sample preparation base material including: a base material body that includes: a flow path in which a medium solution is made to flow; a solution injection section that opens at one end of the flow path and into which the medium solution is injected; and a droplet supporting section that opens at the other end of the flow path and that supports a droplet of the medium solution injected from the solution injection section, in a hanging state, with a surface of the droplet being partially exposed, and an outside-air entry preventing member that prevents entry of outside air from the solution injection section into the droplet supporting section, in the flow path of the base material body.

According to this aspect, in the base material body, the medium solution is injected from the solution injection section, which opens at one end of the flow path, and a droplet thereof is supported, in a hanging state, with the surface thereof being partially exposed, by the droplet supporting section, which opens at the other end of the flow path.

In this state, entry of outside air from the solution injection section into the droplet supporting section, in the flow path of the base material body, is prevented by means of the outside-air entry preventing member, thereby making it possible to prevent a droplet that has become a gel or a solid from dropping from the base material body even when the liquid for causing the droplet to become a gel or a solid is attached to the droplet, which is made to hang by means of the droplet supporting section, thus increasing the weight of the droplet, or even when the droplet becomes a gel or a solid, thus reducing the action of the surface tension. Furthermore, in a case in which the liquid for again liquefying the droplet that has become a gel or a solid is attached to the droplet that is made to hang by means of the droplet supporting section, thus increasing the weight of the droplet, entry of outside air from the solution injection section into the droplet supporting section is prevented by means of the outside-air entry preventing member, thereby making it possible to prevent the liquefied droplet from dropping from the base material body. Therefore, gelation or solidification of the microscope observation sample and liquefaction thereof can be easily and stably performed.

In the above-described aspect, the outside-air entry preventing member may be formed of a substance having fluidity that is injected from the solution injection section to block the solution injection section or the inside of the flow path.

With this configuration, while pouring the substance having fluidity, which serves as the outside-air entry preventing member, from the solution injection section, air in the flow path can be made to escape from the solution injection section to the outside. Accordingly, it is possible to block the solution injection section or the inside of the flow path without pushing outside air from the solution injection section into the flow path.

In the above-described aspect, the outside-air entry preventing member may be a lid member that blocks the solution injection section by being removably inserted into the solution injection section or by openably covering an opening of the solution injection section.

With this configuration, the solution injection section can be blocked by inserting the lid member, which serves as the outside-air entry preventing member, into the solution injection section or by covering the opening of the solution injection section with the lid member. Furthermore, even after the solution injection section is once blocked by the lid member, the solution injection section can be easily opened by removing the lid member.

In the above-described aspect, the outside-air entry preventing member may be an optically transparent plate-like member that covers an opening of the solution injection section.

With this configuration, the observation target is enclosed in the droplet of the medium solution supported by the base material body, thereby making it possible to observe the observation target in the droplet through the plate-like member by means of a microscope, in a state in which the solution injection section is blocked by the optically transparent plate-like member, which serves as the outside-air entry preventing member.

In the above-described aspect, the outside-air entry preventing member may be a valved plug that can open/close an intermediate position of the flow path.

With this configuration, through a simple task of merely opening/closing the intermediate position of the flow path by means of the valved plug, which serves as the outside-air entry preventing member, it is possible to prevent entry of outside air from the solution injection section into the droplet supporting section and to allow entry of outside air from the solution injection section into the droplet supporting section.

According to a second aspect, the present invention provides a microscope-observation-sample preparation method including: injecting a medium solution from a solution injection section that opens at one end of a flow path of a base material body, the medium solution being substantially transparent at the time of gelation or solidification; supporting, by means of a droplet supporting section that opens at the other end of the flow path of the base material body, a droplet of the medium solution injected from the solution injection section, in a hanging state, with a surface of the droplet being partially exposed, and an observation target being enclosed in the droplet; preventing entry of outside air from the solution injection section into the droplet supporting section, in the flow path of the base material body, in which the droplet is supported; and causing the droplet, which is supported by the droplet supporting section, to become a gel or a solid, in a state in which entry of outside air into the droplet supporting section is prevented.

According to this aspect, in the base material body, the droplet of the medium solution injected from the solution injection section, which opens at one end of the flow path, is supported by the droplet supporting section, which opens at the other end of the flow path, in a hanging state, with the surface of the droplet being partially exposed, and the observation target being enclosed in the droplet. Then, in a state in which entry of outside air from the solution injection section into the droplet supporting section, in the flow path of the base material body, is prevented, the droplet of the medium solution, which is supported by the droplet supporting section, is made to become a gel or a solid.

Accordingly, light produced in the observation target, which is enclosed in the droplet of the medium solution supported by the base material body, can be detected outside the gel-state or solid-state substantially transparent droplet of the medium solution, and the observation target can be observed with high-definition.

In this case, even when the liquid for causing the medium solution to become a gel or a solid is attached to the droplet, thus increasing the weight of the droplet, or even when the droplet becomes a gel or a solid, thus reducing the action of the surface tension, because outside air does not enter the droplet supporting section from the solution injection section, the droplet that has become a gel or a solid can be prevented from dropping from the base material body. Furthermore, if entry of outside air from the solution injection section into the droplet supporting section is prevented, even in a case in which the liquid for liquefying again the droplet that has become a gel or a solid is attached to the droplet, thus increasing the weight of the droplet, it is possible to prevent the liquefied droplet from dropping from the base material body. Therefore, it is possible to easily prepare a microscope observation sample for which gelation or solidification and liquefaction can be easily and stably performed.

### REFERENCE SIGNS LIST

1 preparation base material
3, 17, 19 base material body
5 flow path
7 injection section (solution injection section)
9 hanging-drop forming section (droplet supporting section)
11 fluid member (outside-air entry preventing member)
13 lid member (outside-air entry preventing member)
15 plate-like member (outside-air entry preventing member)
S spheroid (observation target)

1. A microscope-observation-sample preparation base material comprising:
a base material body that includes:
a flow path in which a medium solution is made to flow;
a solution injection section that opens at one end of the flow path and into which the medium solution is injected; and
a droplet supporting section that opens at the other end of the flow path and that supports a droplet of the medium solution injected from the solution injection section, in a hanging state, with a surface of the droplet being partially exposed, and
an outside-air entry preventing member that prevents entry of outside air from the solution injection section into the droplet supporting section, in the flow path of the base material body.

2. A microscope-observation-sample preparation base material according to claim 1, wherein the outside-air entry preventing member is formed of a substance having fluidity that is injected from the solution injection section to block the solution injection section or the inside of the flow path.

3. A microscope-observation-sample preparation base material according to claim 1, wherein the outside-air entry preventing member is a lid member that blocks the solution injection section by being removably inserted into the solution injection section or by openably covering an opening of the solution injection section.

4. A microscope-observation-sample preparation base material according to claim 1, wherein the outside-air entry preventing member is an optically transparent plate-like member that covers an opening of the solution injection section.

5. A microscope-observation-sample preparation base material according to claim 1, wherein the outside-air entry preventing member is a valved plug that can open/close an intermediate position of the flow path.

6. A microscope-observation-sample preparation method comprising:
injecting a medium solution from a solution injection section that opens at one end of a flow path of a base material body, the medium solution being substantially transparent at the time of gelation or solidification;
supporting, by means of a droplet supporting section that opens at the other end of the flow path of the base material body, a droplet of the medium solution injected from the solution injection section, in a hanging state, with a surface of the droplet being partially exposed, and an observation target being enclosed in the droplet;
preventing entry of outside air from the solution injection section into the droplet supporting section, in the flow path of the base material body, in which the droplet is supported; and
causing the droplet, which is supported by the droplet supporting section, to become a gel or a solid, in a state in which entry of outside air into the droplet supporting section is prevented.
